(19) United States
(12) Patent Application Publication
(10) Pub. No.: US 2024/0246039 A1
(43) Pub. Date: Jul. 25, 2024

(54) LAYERED MICROPOROUS MEMBRANE PRODUCTS AND RELATED METHODS

(71) Applicant: ENTEGRIS, INC., Billerica, MA (US)

(72) Inventors: Mahesh Narkhede, Woburn, MA (US); Vinay Kalyani, Salem, NH (US)

(21) Appl. No.: 18/417,576

(22) Filed: Jan. 19, 2024

Related U.S. Application Data
(60) Provisional application No. 63/439,986, filed on Jan. 19, 2023.

(51) Int. Cl. B01D 69/12; B01D 67/00; B01D 69/02; B01D 71/26

(52) U.S. Cl. CPC B01D 69/1213; B01D 67/0083; B01D 67/0086; B01D 67/009; B01D 69/02; B01D 69/1214; B01D 69/1216; B01D 71/261; B01D 71/262; B01D 2323/56; B01D 2323/58; B01D 2325/02; B01D 2325/04

(57) ABSTRACT

Described are porous membrane products that contain two or more membrane layers bonded together at a portion of the area of the membranes, methods and system for preparing the porous membrane products, and methods of using the porous membrane products.

### FIELD

This disclosure relates to porous membrane products that contain two or more membrane layers bonded together at a portion of the area of the membranes, methods and system for preparing the porous membrane products, and methods of using the porous membrane products.

### BACKGROUND

Porous polymeric membranes, including those known as microporous membranes, are used for removing contaminants from various types of fluids. Some membranes are useful to remove general classes of contaminants from a fluid. Others may be designed to remove particular types of contaminants from a fluid. Many varieties of microporous membranes are designed for general and specialized applications.

Fluids that are treated to remove unwanted materials include water, liquid industrial solvents and processing fluids, industrial gases used for manufacturing or processing, liquids that have medical or pharmaceutical uses, and liquids that are used in semiconductor and microelectronic device manufacturing. Unwanted materials that are removed from fluids include impurities and contaminants such as particles, microorganisms, airborne molecular contaminants, and dissolved chemical materials.

For some filtering applications, two different types of porous membranes may be used together, in series, to remove multiple types of contaminants from a flow of a single fluid. Two or more different types of porous membranes may be assembled in different arrangements to form a multi-membrane (multi-layer) assembly that is designed to remove multiple targeted materials from a single flow of fluid. For example, some types of porous membranes function to remove impurities from a fluid via a sieving mechanism in which contaminants present within a fluid are physically trapped by pores of the membrane based on size. Other types of membranes function via a non-sieving mechanism by which impurities that are smaller than the membrane pores are trapped within the porous membrane by chemical or electrostatic attraction of the impurity to the membrane material. By combining a non-sieving membrane with a sieving membrane, both large and smaller particles may be removed.

Technical challenges exist when producing a multi-membrane filter assembly from two or more individual membranes. Processes that are used for bonding separate porous membranes together into a multi-layer filter assembly can have a detrimental effect on performance properties of the individual membranes, such as a reduced fluid flow through the membrane.

By some methods, multi-membrane filter assemblies are prepared by bonding surfaces of individual membranes together, for example by placing an adhesive material at membrane surfaces, with compression, to bond one membrane to another membrane. However, the adhesive can interfere with membrane performance by clogging pores, and pores may be collapsed or deformed by compression. Additionally, the presence of the adhesive can add impurities into a fluid that passes through the assembly.

As an alternative to bonding the membranes, different membranes may be generally positioned in a “stacked” arrangement of separate membranes, without being bonded at their surfaces, to preserve their individual filtration properties. However, handling such a filter, in which individual layers are not adhered together, can be difficult, particularly when one or both of the layers are very thin.

Yet another version of a multi-membrane filter assembly is a composite membrane formed by a lamination process that bonds two separate polymeric porous membranes together by placing the membranes in a “stacked” assembly, with contacted surfaces, and applying heat and pressure to bond the membranes into a composite. See United States Patent 2021/0365092.

These previous modes of preparing multi-membrane filter assemblies have various shortcomings, or opportunities for improvement. Users of filtration technology maintain an ongoing need to increase the capabilities of filter products, including multi-membrane filter assemblies.

### SUMMARY

The following description relates to multi-membrane filter assemblies that are prepared from two or more separate polymeric microporous membranes, as well as to methods and systems for preparing and using these filter assemblies.

Methods of the present description involve bonding two or more different polymeric microporous membranes together to form a “multi-layer membrane” that includes bonds that are formed between the two membranes at only a portion of the area of the membranes, preferably over a relatively small portion of the area of the membranes. By example methods, two or more membranes are secured together at their adjacent surfaces (“bonded” together) by forming bonds at bond areas that cover a portion of the membranes, preferably a minor or small portion of the materials, without affecting non-bonded areas of the membranes. By a specific example, two or more membranes are bonded together by forming a pattern of separate, discrete bonds or “welds” between the two membranes. No adhesive is required.

Compared to known methods of bonding porous membranes together, the present methods can provide a reduced impact on the performance of the multi-membrane filter assembly that is produced. The process of forming a bond between membranes can have a detrimental impact on filtration performance of the individual membranes, such as a reduction in flow through the membranes at locations of the bonds. Methods as described form bonds between the membranes at only a portion of the total area of the membranes, and a reduced performance (e.g., flow) that is caused by bonds is limited to the area of the bonds. The non-bonded areas, which are most of the areas of the bonded membranes, retain the original performance of the individual membranes.

Additionally, the described methods can be effective to produce multi-membrane filter assemblies from combinations of two or more different types of microporous membranes that have varied physical properties. Membranes that are bonded together may have different or complementary properties that include: filtration mechanisms (sieving, non-sieving), chemical composition, pore size, thickness, melting temperature, bubble point, porosity, or the ability to remove different contaminants from a particular type of fluid. According to a particular example, a multi-membrane filter assembly may be prepared from two or more membranes, including one membrane that operates by a sieving filtration mechanism and a second membrane that operates by a non-sieving mechanism.

By previous methods, such as thermal surface lamination, effective multi-layer filter assemblies can be formed from different materials, but the choice of materials may be limited by the properties of the membranes such as melting or softening temperature. These processes work well with membranes that have similar properties, but may be successful for combining membranes that have disparate melting or softening temperatures.

The methods do not require that the individual membranes that are being bonded together have similar melting points, and the methods are useful to bond together two or more membranes that have melting points that dissimilar. Moreover, the methods can be adapted to form multi-membrane filter assemblies from three or more different individual membranes.

The present methods are useful alternatives to previous techniques for forming multi-membrane filter assemblies, and can be in useful to produce multi-layer filter assemblies that have novel and useful combinations of membrane materials, with useful or improved filtering performance.

In one aspect, the description relates to a method of forming a layered polymeric microporous membrane that has a first microporous membrane bonded to a second microporous membrane at multiple bond areas. The method includes: contacting a surface of the first microporous membrane with a surface of the second microporous membrane, and forming bonds between the surface of the first microporous membrane and the surface of the second microporous membrane, at multiple bond areas, by applying energy to the bond areas.

In another aspect, the description relates to a layered polymeric microporous membrane. The layered membrane includes: a first polymeric microporous membrane, and a second polymeric microporous membrane bonded to the first polymeric microporous membrane at bond areas that cover less than 20 percent of the area of the layered polymeric microporous membrane.

### BRIEF DESCRIPTION OF THE DRAWINGS

FIGS. 1A, 1B, and 1C show example systems and methods as described.

FIGS. 2A, 2B, and 2C show example systems and methods as described.

FIG. 3 shows an example of a filter product as described.

The figures are schematic and not necessarily to scale.

### DETAILED DESCRIPTION

The following description relates to multi-membrane filter assemblies, sometimes also referred to herein as “multi-layer membranes” or “layered membranes,” that are prepared from two or more individual polymeric microporous membranes, and to methods and systems for preparing and using these filter assemblies.

The multi-membrane filter assembly is a combination of two or more individual polymeric microporous membranes that are bonded together at bond areas (a.k.a., “weld areas”) that make up only a portion of the area of the membrane, and that are formed from the polymer materials of the polymeric microporous membranes.

The described layered membranes are different from previous multi-membrane filter assemblies, including previous multi-layer composite membranes that are made by bonding two individual membranes together by a lamination step that includes heat and compression applied over the entire area of the individual membranes. Specifically, compared to a laminated composite membrane, the layered membrane of the present description includes bonded areas that cover only a portion of the area of the membrane.

The bonds (a.k.a. “welds”) that hold surfaces of the two membranes together are formed from the polymeric material of the membranes, without the need for an added adhesive material. For purposes of this feature of the membranes, an adhesive is a material that is not a component of a microporous membrane, that is added to a surface of a microporous membrane for the purpose of causing the membrane to adhere to a second membrane. Examples include adhesives that are known as pressure-sensitive adhesives, structural adhesives, thermoplastic adhesives, curable adhesives (e.g., thermosetting or radiation-curable adhesives) etc., that are applied to a surface and flow onto the surface, and solidify to adhere to the surface. Example adhesives may contain a reactive or non-reactive polymer selected from an epoxy polymer, a polyacrylate, and a silicone, among others.

To form the bonds as described, surfaces of the membranes are contacted with each other and energy is applied at only a portion of the area of the membranes, to form bonds at the limited area, referred to as “bond areas” or “weld areas.” The energy increases the temperature of the membranes at the bond areas to a temperature that causes polymer of the membranes to soften or melt and become fused together to a degree that is sufficient for the two membranes to adhere together at the bond areas when the temperature of the membranes is allowed to decrease, such as to room temperature (e.g., 20 to 25 degrees Celsius).

According to useful examples, bond areas cover less than 20 percent of the area of a layered membrane, e.g., less than 10 percent or 5 percent of the area of a layered membrane, such as from 0.5 to 10 percent of the area of the layered membrane. The remaining area of the membranes, the “non-bonded” area, includes membranes that are in contact at adjacent surfaces but are not bonded together. The amount of non-bonded area of a layered membrane may be least 80, 90, 95, 97, or 99.5 percent of the area of the layered membrane.

The bond areas can have any size and shape. Example bond areas may include a regular pattern of connected or un-connected lines, or a pattern of separate geometric shapes such as dots, squares, triangles, etc. A bond area may have any useful dimensions, such as at least one dimension on a scale of millimeters, e.g., less than 5, 3, or 1 mm.

The layered membrane includes two or more individual layers (membranes) that are bonded together at bond areas as described. Useful polymeric microporous membranes (also referred to as “microporous membranes” or “membranes” for short) include polymeric microporous membranes that can be bonded together by application of energy at bond areas by a method of the present description, to provide a useful multi-membrane filter assembly.

An individual membrane that may be used to form a layered membrane may be characterized as an open pore polymeric microporous membrane (e.g., in the form of a thin sheet or film) that contains interconnected pores that form passages that extend from one surface of the membrane to the opposite surface of the membrane. The passages provide tortuous tunnels or paths through which a fluid being filtered must pass. Contaminants in the fluid are removed from the fluid by being captured by the membrane either mechanically or electrostatically, e.g., by a “sieving” or a “non-sieving” mechanism, or both. A sieving mechanism is a mode of filtration by which a contaminant is removed from a flow of liquid by retention at a membrane pore due to mechanical interference of the pore with movement of the contaminant. For example, a dimension of the size of the contaminant may be larger than a size of a pore of the membrane. A “non-sieving” filtration mechanism is a mode of filtration by which a filtration membrane retains a contaminant that is contained in a fluid flowing through the membrane in a manner that is not exclusively mechanical, e.g., that includes an electrostatic mechanism by which the contaminant is electrostatically attracted to and retained at a surface of the filtration membrane.

Useful membranes include open pore membranes that have pore sizes in a range of microns, these membranes being referred to herein as “microporous” membranes. Typical average pore sizes are in the micron or sub-micron range, such as from about 0.001 micron to about 10 micron. Membranes with an average pore size of from about 0.001 to about 0.05 micron are sometimes classified as ultrafiltration membranes. Membranes with average pore sizes between about 0.05 and 10 microns are sometimes classified as microporous membranes. Membranes can also be characterized as nanoporous membranes, which are characterized by pores having an average pore size in a range of nanometers and sub-nanometers, e.g., from 0.5 to 100 nanometers.

Porous membranes can also be characterized based on “porosity.” As used herein, a “porosity” of a porous membrane (also sometimes referred to as “void fraction”) is a measure of the void (i.e. “empty”) space in the membrane as a percent of the volume of the membrane, and is calculated as a fraction of the volume of voids of the membrane over the total volume of the membrane. A membrane that has zero percent porosity is completely solid. Examples of useful membranes can have a porosity that allows a membrane to be effective as described herein, to allow a suitable flow rate of fluid to pass through the membrane while also removing a high portion of contaminants or impurities from the fluid. Examples of useful membranes can have a porosity of up to 80 percent, e.g., a porosity in a range from 30 to 70 percent of from 40 to 60 percent

Various types of polymers are known and useful for forming microporous membranes. Examples include: thermoplastic polymers, polyolefins such as polypropylene and polyethylene, polysulfones, polyimides, polyamides, and fluoropolymers (e.g., polytetrafluoroethylene or “PTFE”). More particular examples include ultrahigh molecular weight polyethylene (“UHMWPE”), stretched polyethylene, stretched polypropylene, and polytetrafluoroethylene.

According to example multi-membrane filter assemblies, an assembly may be prepared by bonding together two or more individual membranes that have different and complementary physical features (e.g., thickness), filtration properties, or processing properties. The membranes may have different or complementary properties that include: filtration mechanisms (sieving, non-sieving), chemical composition, pore size, thickness, melting temperature, bubble point, porosity, or the ability to remove different contaminants from a particular type of fluid.

A multi-membrane filter assembly (“layered membrane”) may, for example, be formed from two or more individual microporous membranes that have different filtering mechanisms. A layered membrane may be formed to include a combination of one microporous membrane that removes contaminants from a fluid by a sieving mechanism (a “sieving membrane”), combined with a second microporous membranes that removes contaminants from a fluid by a non-sieving mechanism (a “non-sieving membrane”). Additionally or alternately, the sieving and the non-sieving membranes may have different chemical compositions, thicknesses, porosities, pore sizes (bubble points), etc.

More particularly, a first membrane may be a sieving membrane that exhibits a relatively high bubble point, such as a bubble point of at least 150 pounds per square inch (psi), or at least 180 psi, or at least 200 psi, measured either as an initial bubble point or as a mean bubble point. Examples sieving membranes that exhibit a high bubble point include membranes made may also have a porosity that is less 50 or 60 percent (e.g., from 40 to 55 percent), and a thickness that is less than 20 μm (microns), including less than 15 μm and less than 10 μm. Examples of such membranes may be made of stretched (e.g., bi-axially stretched) polyolefin (polypropylene or polyethylene), or fluoropolymer.

A second microporous membrane may be a non-sieving membrane, which compared to a sieving membrane may be relatively thicker and may have a lower bubble point. Examples of non-sieving membranes may have a bubble point that is below 150 psi, e.g., in a range from 50 to 150 or from 100 to 150 psi measured either as an initial bubble point or as a mean bubble point, a porosity that is greater than 40 or 50 percent (e.g., from 45 to 70 percent), and may have a thickness in a range of from 5, 10, 20, or 50 microns up to 200 microns, e.g., a thickness in a range from 100 to 200 microns. A non-sieving membrane may optionally be surface-treated to provide enhanced non-sieving retention of contaminants. Examples of non-sieving membranes may be melt-cast, non-stretched microporous membranes prepared from nylon, polyolefin (e.g., polyethylene, ultrahigh molecular weight polyethylene), or fluoropolymer, any of which may be surface-modified to exhibit an electrostatic charge.

Bubble point is a feature of a membrane that correlates to the sizes of pores (i.e., average pore size) of the membrane. A smaller pore size of a membrane can correlate to a higher bubble point and often to higher filtering performance, such as higher retention of smaller-sized particles. Normally, however, a higher bubble point also correlates to relatively higher resistance of flow through a porous membrane, and a lower rate of flow of a fluid for a given pressure drop.

By one method of determining a bubble point of a porous membrane, a sample of membrane is placed in a holder. Air is pressurized through the holder and the flow rate measured as a function of pressure. This is known as dry air flow. A low surface tension fluid, HFE-7200 (3M) is introduced to the membrane to wet the membrane. The gas pressure is gradually increased. The pressure at which the gas first flows through the sample as a bubble is called an initial bubble point. The mean bubble point is the pressure at which the ratio of the air flow of the wet membrane to the air flow of the dry membrane is 0.5. The test is performed at a temperature in a range of between 20 and 22 degrees Celsius

The individual membranes used to form a layered membrane may also be characterized based on melting temperature. Different layers of a layered membrane may have the same or similar melting temperatures, but are not required to have the same or similar melting properties. Two individual membranes made to prepare a layered membrane may have melting points that are dissimilar, e.g., that differ by at least 10, 20, or 30 degrees Celsius. As a particular example, one membrane may be polypropylene, and a second membrane may be polyethylene, with the two membranes having melting points that differ by at least 10, 20, or 30 degrees Celsius.

Additionally, the described thermal lamination methods and ultrasonic methods may be generally used to form multi-membrane assemblies that include two or more membranes that have a combination of different thickness ranges. The methods may be used to bond two or more membranes that each have a small thickness, e.g., two or more membranes having thicknesses in a range from 5 to 100 microns or from 10 to 50 microns. The methods may also be used to bond two or more membranes that have larger thicknesses, e.g., two or more membranes having thicknesses of greater than 100 microns or greater than 200 microns. Also, the methods may be used to bond two or more membranes that have a combination of small and large thicknesses, e.g., to bond a first membrane having thicknesses in a range from 5 to 100 microns to a second membrane having a thickness of greater than 100 microns or greater than 200 microns.

Methods of the present description involve attaching (bonding) two or more different polymeric microporous membranes together at bonds that are formed at only a portion of the area of the membranes, preferably over a relatively small portion of the area of the membranes. By example methods, two or more membranes are adhered together at their adjacent surfaces (“bonded” together) by bonds that cover only a portion of the total area of the membranes, preferably a minor or small portion of the area of the membranes, without the need for an added adhesive material at the bond areas, and without significantly affecting filtration properties (e.g., flow, retention) or morphology (e.g., pore size, porosity, bubble point) of the membranes at the non-bonded areas.

Compared to other methods of bonding membranes together, the present methods can have a reduced detrimental impact on the performance of the multi-membrane filter assembly that is produced. Generally, a process of forming a bond between two individual membranes by applying heat, compression, or an added adhesive, can reduce the filtering performance of the individual membranes, such as by causing a reduction in flow through a membrane. Methods as described form bonds between membranes at only a portion of the total area of the membranes, and any detrimental effect on performance (e.g., reduced flow) that is caused by forming the bond is limited to the area of the bond. The non-bonded area of the membranes, which can be a major portion or most of the area of the bonded membranes, retains the original performance of the individual membranes.

According to the described methods, a bond is formed between two or more polymeric microporous membranes at a bond area by applying energy to the bond area in an amount sufficient to form the bond, while avoiding application of the same amount of energy to non-bonded areas of the membranes. To form the bond, two or more membranes are brought into contact, and energy is applied to increase the temperature of the two membranes at the bond area. The temperature of the bond area is increased to a temperature that causes polymer of the membranes, at the bond area, to soften or melt and to become fused together to a degree that is sufficient for the two membranes to adhere together at the bond area when the temperature of the two membranes is allowed to decrease, such as to room temperature (e.g., 20 to 25 degrees Celsius).

To form a bond at a bond area, a temperature of an individual membrane at the bond area may be increased to a temperature at which the membrane either softens or melts to cause polymer of the membrane to combine with polymer of an adjacent contacted membrane to form a bond when the membranes cool. The energy is applied to cause one or both of the membranes to soften or melt. With the membranes being held in contact with at least a slight amount of pressure, the softened or melted polymers of the membranes at the bond area can flow or otherwise become combined to form a bond between the two membrane surfaces. In specific example methods, at least one of the membranes can be heated to a temperature that is above a melting temperature of the membrane. In other example methods, two or more membranes that are in contact with each other are both heated to a temperature that is above the melting temperature of both membranes.

The energy may be in the form of heat energy that is transferred to the membranes from a heated surface, or ultrasonic energy, or another useful form of energy. The energy can be applied to bond areas using any useful energy source, and with a high degree of precision to cause the temperature of the bond area to increase without causing a similar increase in the temperature of non-bonded areas of the membranes. The non-bonded areas may experience a temperature increase, but do not reach a temperature that causes the polymer of a membrane at the non-bonded areas to soften or to melt and adhere together. Preferably, the non-bonded areas of the membranes do not experience a significant change in morphology or flow properties, and the non-bond areas of the membrane retain a level of flow through the membrane, an average pore size, bubble point, and porosity that are substantially unchanged by the process of forming bonds at the bond areas.

According to examples methods, ultrasonic energy is used form the bond. Two microporous membranes are held in contact at their surfaces, and pressure is applied at bond areas to hold surfaces of the membrane in contact. While the surfaces at the bond areas are held in contact, ultrasonic energy is applied to the membranes to raise the temperature of the membranes at bond areas. The ultrasonic energy increases the temperature of the polymers of the two membranes to cause polymer at the bond areas to flow together or commingle. Subsequently, by allowing the heated polymers to cool, a bond (or “weld”) is created at the bond areas by the commingled polymers. Using these processes, the heat is applied with a high degree of precision at the bond areas, and polymer at the areas of the membrane other than the bond areas (i.e., the non-bond areas of the membrane) does not experience a temperature increase that significantly affects the properties of the membranes.

Ultrasonic welding techniques are effective for forming layered membrane products as described by applying ultrasonic energy to bond areas of two contacting membranes to raise the temperature of polymer of the membranes at the bond areas, to cause the heated polymer form bonds at the bond areas without significantly affecting properties of the membranes at non-bond areas. Example ultrasonic welding techniques may use ultrasonic energy at a high frequency (e.g., from 20 to 40 kHz) to produce low amplitude (e.g., from 1 to 25 μm) mechanical vibrations to generate heat at the bond areas. The heat can cause the polymer at the bond areas to soften or melt and to become fused together such that when the polymer cools the polymer at the bond areas has formed a bond or a “weld” between the two membranes.

An alternate form of energy applied to bond areas may be heat energy that is applied to the membranes while the membranes are held in contact at the bond areas, with amount of pressure that is sufficient to hold the surfaces together for bonding. The heat energy may be applied to the bond areas through heated surfaces that contact only the bond areas, without substantially increasing the temperature of the non-bond areas of the membranes.

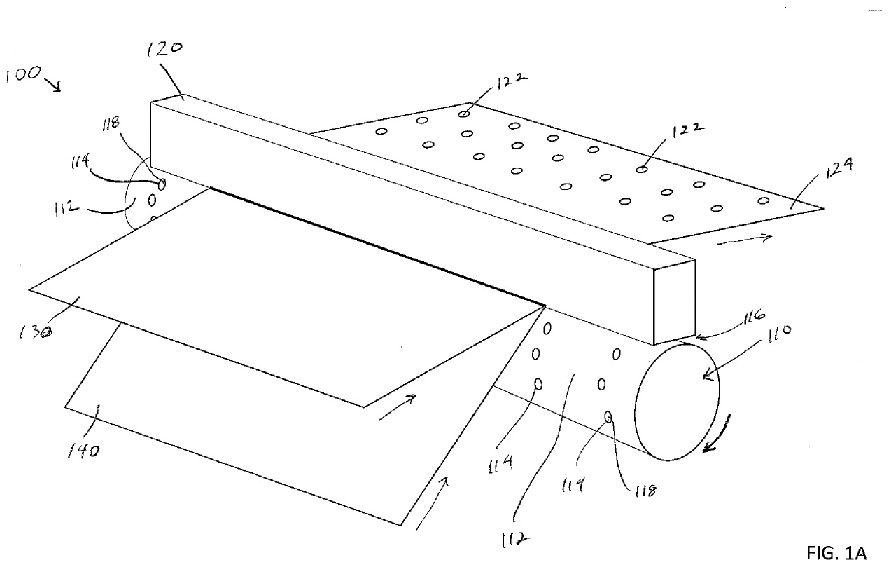

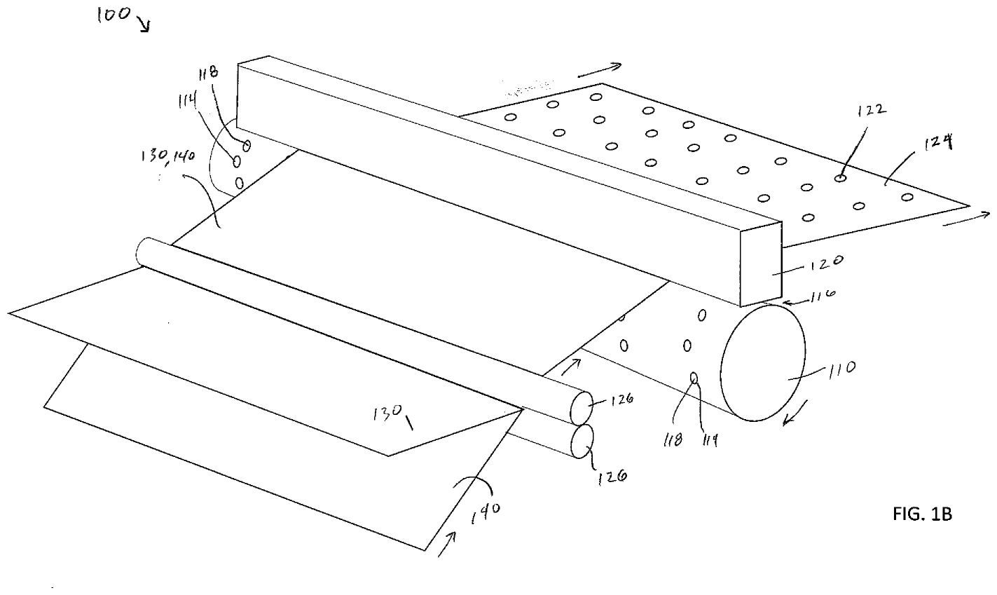

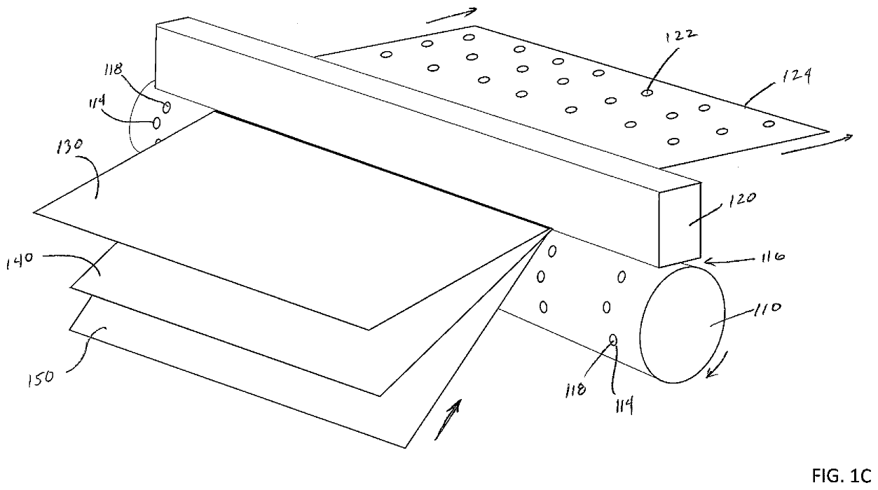

A system and a method useful to form a layered membrane as described are shown at FIGS. 1A, 1B, and 1C. At FIG. 1A, ultrasonic welding apparatus 100 includes rolling anvil 110 and “sonotrode” (a.k.a. “horn”) 120. Rolling anvil 110 has a rolling cylindrical surface 112 that includes a pattern of multiple heightened extensions 114, which are protrusions that extend radially a distance above surface 112. Each extension 114 includes a weld surface 118 located at the end of the extension. Horn 120 is located a distance away from rolling anvil 110 along the length of rolling anvil 110 to form gap 116 between welding surfaces 118 of anvil 110 and horn 120. Gap 116 can be defined as a distance between the welding surfaces 118 at the ends of extensions 114 and a surface of horn 120 that faces extensions 114. The size of the gap can be approximately equal to the combined thicknesses of membranes (130, 140), which travel through gap 116 during use. The size of the gap can allow the membranes to pass through the gap while applying a slight amount of pressure to the membranes to maintain contact between the membranes during bonding.

In use, microporous membranes 130 and 140 are held together at surfaces of the membranes and passed through gap 116 while anvil roller 110 rotates and while the membranes travel with the rolling surface of rolling anvil 110 (see arrows). Anvil roller 110 is rotatably supported at its opposite ends as part of apparatus 100 in a manner to allow the anvil roller to contact a lower surface of the assembly of membranes 130 and 140 and move the assembled and contacting membranes beneath horn 120 through gap 116.

As the membranes 130 and 140 pass beneath horn 120, while supported at weld surfaces 118, horn 120 produces ultrasonic energy that is adsorbed by polymer of the membranes. The ultrasonic energy increases the temperature of the membranes to cause the polymer of the membranes to soften or melt at bond areas that contact surfaces 118, and fuse together upon being cooled. The bonded membranes form layered membrane 124 passing from assembly 100, which includes bond areas 122.

Referring to FIG. 1B, welding apparatus 100 is a variation of welding apparatus 100 of FIG. 1A. Apparatus 100 of FIG. 1B includes nip rollers 126 at an upstream location relative to anvil roller 110 and horn 120. Nip rollers 126 receive membrane 130 and membrane 140 and place the surfaces of the membranes into contact with each other at a location before the membranes contact anvil roller 110, and are effective to remove air from between the membranes before the membranes are bonded at anvil roller 110 and horn 120.

Referring to FIG. 1C, welding apparatus 100 is a variation of welding apparatus 100 of FIG. 1A. Apparatus 100 of FIG. 1C includes a third membrane 150 that is part of an assembly of membranes (130, 140, and 150) that is passed through gap 116, and that are processed by forming bond areas 122 of layered membrane 124. According to the method of FIG. 1C, three or more membranes may be used to form a layered membrane 124 that is bonded together at bond areas 122.

Compared to other methods of forming a multi-membrane filter assembly from multiple individual polymeric microporous membranes, e.g., lamination methods that affect the entire area of the membranes, a method as described is more capable of forming a layered membrane from three or more separate membranes, because the layered membrane forms bond between the three or more layers at limited areas of the membranes, i.e., at the bond areas, and not over the entire surface of the membranes. While the bonds may cause a detrimental effect on filtering performance of the layered membrane at the bond areas, the amount of area of the bonds is limited, and the performance of the non-bond areas is un-affected by the bonding process.

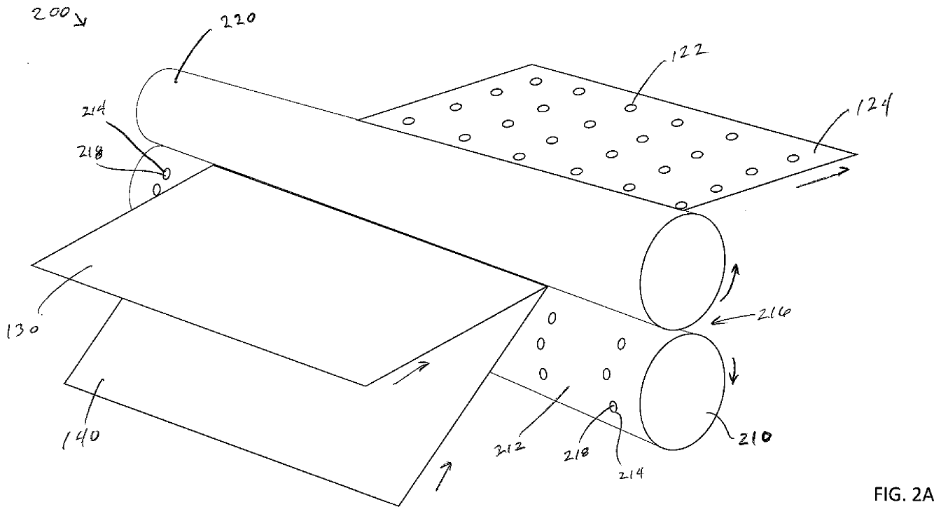

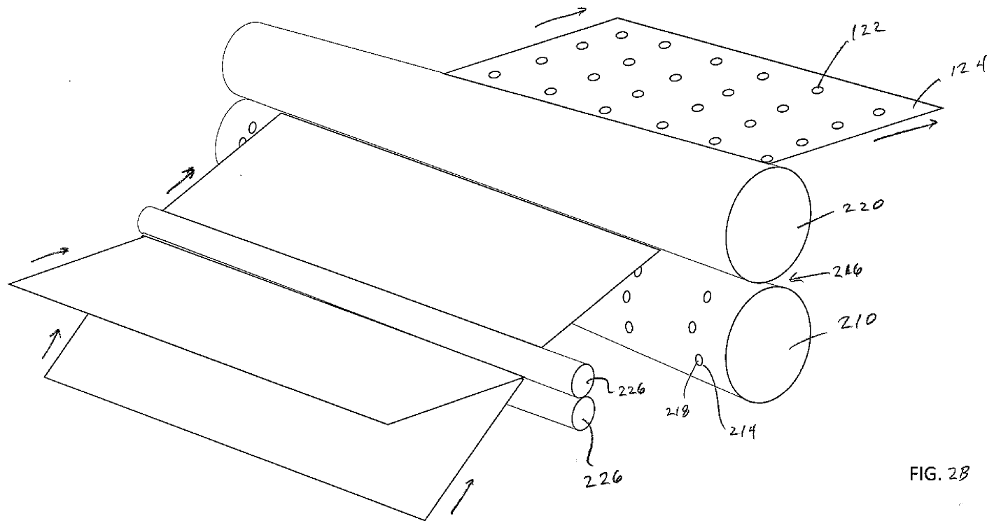

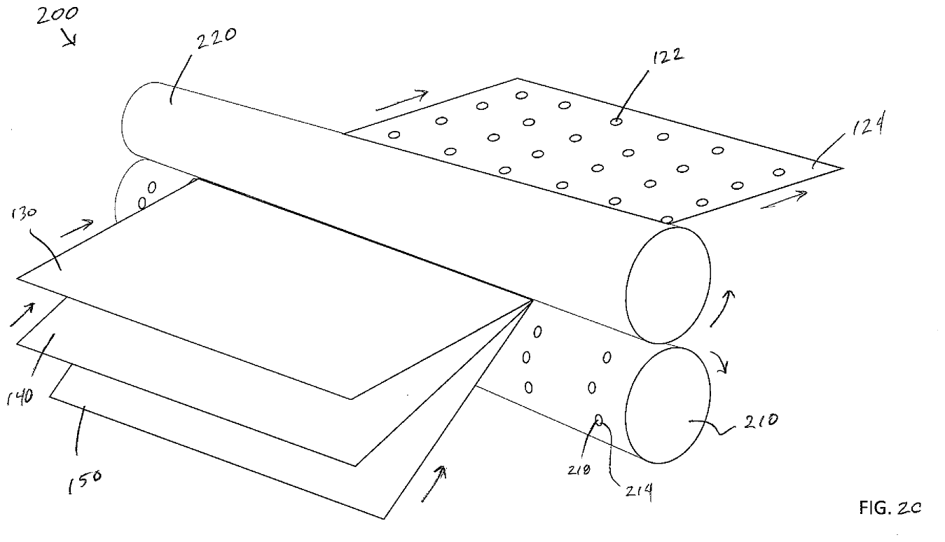

According to alternate methods shown at FIGS. 2A, 2B, and 2C, bond areas may be formed not by ultrasonic energy applied to the bond areas, but by thermal energy applied to bond areas by heated surfaces. As shown at FIGS. 2A, 2B, and 2C, ultrasonic welding apparatus 200 includes rolling anvil 210 and roller 220. Rolling anvil 210 has a rolling cylindrical surface 212 that includes a pattern of multiple heightened heated extensions 214, which are protrusions that extend radially a distance above surface 212. Each heated extension 214 includes a heated weld surface (“heated surface”) 218 located at the end of the extension. In alternate examples, the surface of roller 220 may be heated and extensions 214 and surfaces 218 may be either heated or un-heated.

Roller 220 is located a distance away from rolling anvil 210 along the length of rolling anvil 210 to form gap 216 between heated surfaces 218 of anvil 210 and horn 120. Gap 216 can be defined as a distance between the heated surfaces 218 at the ends of extensions 214 and a surface of roller 220 that faces extensions 114. The size of gap 216 can be approximately equal to the combined thicknesses of membranes (130, 140), which travel through gap 216 during use. The size of the gap can allow the membranes to pass through the gap while applying a slight amount of pressure to the membranes to maintain contact between the membranes during bonding.

In use, microporous membranes 130 and 140 are held together at surfaces of the membranes and passed through gap 216 while anvil roller 210 and roller 220 rotate (see arrows). As the membranes pass through gap 216, heated surfaces 218 contact weld areas of the membranes and apply heat to the weld areas to raise the temperature of the weld areas. The increase in temperature causes polymer of the membranes at the bond areas to soften or melt, and fuse together upon being cooled. The bonded membranes form layered membrane 124 passing from assembly 100, which includes bond areas 122.

Referring to FIG. 2B, welding apparatus 200 is a variation of welding apparatus 200 of FIG. 2A. Apparatus 200 of FIG. 2B includes nip rollers 226 at an upstream location relative to anvil roller 210 and roller 220. Nip rollers 226 receive membrane 130 and membrane 140 and place the surfaces of the membranes into contact with each other at a location before the membranes pass through gap 216, and are effective to remove air from between the membranes before the membranes are bonded by contact with heated surfaces 218 when passing between anvil roller 210 and roller 220 at gap 216.

Referring to FIG. 1C, welding apparatus 200 is a variation of welding apparatus 200 of FIG. 2A. Apparatus 200 of FIG. 2C includes a third membrane 150 that is part of an assembly of membranes (130, 140, and 150) that is passed through gap 216, and processed by forming bond areas 122 of layered membrane 124. According to the method of FIG. 2C, three or more membranes may be used to form a layered membrane 124 that is bonded together at bond areas 122.

A multi-membrane filter assembly (“filter membrane”) as described herein, or a filter or filter component that contains the filter membrane, can be useful in a method of filtering a liquid chemical material to purify or otherwise remove unwanted material from the liquid chemical material, especially to produce a highly pure liquid chemical material that is useful for an industrial process that requires chemical material input that has a very high level of purity. Generally, the liquid chemical may be any of various useful commercial materials, and may be a liquid chemical that is useful in any of a variety of different industrial or commercial applications. Particular examples of filter membranes as described can be used for filtering or purifying a liquid chemical that is used in a semiconductor or microelectronic fabrication application, e.g., for filtering a liquid solvent or other process solution used in a method of semiconductor photolithography, a wet etching or cleaning step, ultrapure water or plating chemistry.

Some specific, non-limiting, examples of liquid solvents that can be filtered using a filter membrane as described include: n-butyl acetate (nBA), isopropyl alcohol (IPA), 2-ethoxyethyl acetate (2EEA), cyclohexanone, ethyl lactate, gamma-butyrolactone, hexamethyldisilazane, methyl-2-hydroxyisobutyrate, methyl isobutyl carbinol (MIBC), n-butyl acetate, methyl isobutyl ketone (MIBK), isoamyl acetate, propylene glycol monoethyl ether, propylene glycol methyl ether (PGME), 2-heptanone, and propylene glycol monomethyl ether acetate (PGMEA).

The filter membrane can be contained within a larger filter structure such as a filter or a filter cartridge that is used in a filtering system. The filtering system will place the filter membrane, e.g., as part of a filter or filter cartridge, in a flow path of a liquid chemical to cause the liquid chemical to flow through the filter membrane so that the filter membrane is able to remove impurities and contaminants from the liquid chemical. The structure of a filter or filter cartridge may include one or more of various additional materials and structures that support the filter membrane within the filter to cause fluid to flow from a filter inlet, through the filter membrane, and thorough a filter outlet, thereby passing through the filter membrane when passing through the filter. The filter membrane supported by the filter structure can be in any useful shape, e.g., a pleated cylinder, cylindrical pads, one or more non-pleated (flat) cylindrical sheets, a pleated sheet, among others.

One example of a filter structure that includes a filter membrane in the form of a pleated cylinder can be prepared to include the following component parts, any of which may be included in a filter construction but may not be required: a rigid or semi-rigid core that supports a pleated cylindrical filter membrane at an interior opening of the pleated cylindrical filter membrane; a rigid or semi-rigid cage that supports or surrounds an exterior of the pleated cylindrical filter membrane at an exterior of the filter membrane; optional end pieces or “pucks” that are situated at each of the two opposed ends of the pleated cylindrical filter membrane; and a filter housing that includes an inlet and an outlet. The filter housing can be of any useful and desired size, shape, and materials, and can preferably be made of suitable polymeric materials.

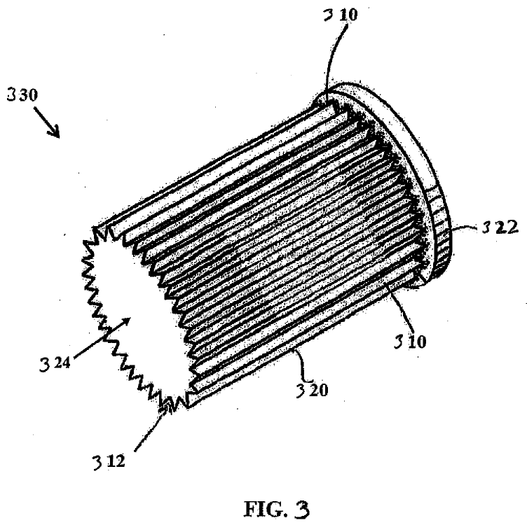

As one example, FIG. 3 shows filter component 330, which is a product of pleated cylindrical component 310 and end piece 322, with other optional components. Cylindrical component 310 includes a filter membrane 312, as described herein, and is pleated. End piece 322 is attached (e.g., “potted”) to one end of cylindrical filter component 310. End piece 322 can preferably be made of a melt-processable polymeric material. A core (not shown) can be placed at the interior opening 324 of pleated cylindrical component 310, and a cage (not shown) can be placed about the exterior of pleated cylindrical component 310. A second end piece (not shown) can be attached (“potted”) to the second end of pleated cylindrical component 330. The resultant pleated cylindrical component 330 with two opposed potted ends and optional core and cage can then be placed into a filter housing that includes an inlet and an outlet and that is configured so that an amount of fluid entering the inlet must necessarily pass through filtration membrane 312 before exiting the filter at the outlet.

The filter housing can be of any useful and desired size, shape, and materials, and can preferably be a fluorinated or non-fluorinated polymer such as nylon, polyethylene, or fluorinated polymer such as a poly(tetrafluoroethylene-co-perfluoro(alkyvinylether)), TEFLON® perfluoroalkoxyalkane (PFA), perfluoromethylalkoxy (MFA), or another suitable fluoropolymer (e.g., perfluoropolymer).

1. A method of forming a layered microporous membrane comprising a first microporous membrane bonded to a second microporous membrane at multiple bond areas, the method comprising:
contacting a surface of the first microporous membrane with a surface of the second microporous membrane, and
forming bonds between the surface of the first microporous membrane and the surface of the second microporous membrane, at multiple bond areas, by applying energy to the bond areas.

2. The method of claim 1, wherein the bond areas cover less than 20 percent of the area of the layered microporous membrane.

3. The method of claim 1, wherein forming a bond comprises applying energy to the first microporous membrane and the second microporous membrane at the bond areas to raise a temperature of the bond areas and cause a polymer of the first microporous membrane to fuse with a polymer of the second microporous membrane at the bond areas.

4. The method of claim 3, comprising:
raising a temperature at the bond areas to a temperature that is: above a melting temperature of the first microporous membrane, above a melting temperature of the second microporous membrane, or above a melting temperature of the first microporous membrane and above a melting temperature of the second microporous membrane, and
allowing the temperature of the bond areas to decrease, with the first microporous membrane being bonded to the second microporous membrane at the bond area.

5. The method of claim 1, wherein the first microporous membrane has a first microporous membrane melting point, the second microporous membrane has a second microporous membrane melting point, and a difference between the first microporous membrane melting point and the second microporous membrane melting point is at least 20 degrees Celsius.

6. The method of claim 1, wherein one of the first microporous membrane or the second microporous membrane comprises a polymer selected from: ultrahigh molecular weight polyethylene, polysulfone, stretched polyethylene, stretched polypropylene, polyimide, polyamide, and polytetrafluoroethylene.

7. The method of claim 1, wherein one of the first and second microporous membranes comprises polyethylene, and one of the first and second microporous membranes comprises polypropylene.

8. The method of claim 1, wherein forming the bonds between the surface of the first microporous membrane and the surface of the second microporous membrane at multiple bond areas comprises applying ultrasonic energy to the bond areas to heat the bond areas.

9. The method of claim 1, wherein forming the bonds between the surface of the first microporous membrane and the surface of the second microporous membrane at multiple bond areas comprises: using a heated surface having an area of the bond areas, applying heat to the bond areas by placing the bond areas between the heated surface and a roller.

10. The method of claim 1, wherein the first microporous membranes is a sieving membrane having:
an initial bubble point of at least 150 pounds per square,
a porosity of less than 55 percent, and
a thickness of less than 20 microns.

11. The method of claim 1 wherein the second microporous membrane has a thickness in a range from 20 to 200 microns.

12. The method of claim 11, wherein the second microporous membranes is a non-sieving membrane having:
an initial bubble point of less than 150 pounds per square,
a porosity of greater that 40 percent, and
a thickness of greater than 50 microns.

13. The method of claim 1, wherein one of the first and second microporous membranes comprises polyethylene and one of the first and second microporous membranes comprises polypropylene.

14. The method of claim 1, comprising:
contacting a surface of the first microporous membrane with a surface of a third microporous membrane, and
bonding the first microporous membrane to the second microporous membrane and to the third microporous membrane at multiple bond areas by
applying energy to bond areas to melt a polymer at the bond areas, and
allowing the melted polymer to solidify to form the bond areas.

15. The method of claim 1, wherein the first microporous membrane has thicknesses in a range from 5 to 100 microns and the second microporous membrane has a thickness in a range from 5 to 100 microns.

16. The method of claim 1, wherein the first microporous membrane has thicknesses in a range from 5 to 100 microns and the second microporous membrane has a thickness greater than 100 microns.

17. The method of claim 1, wherein the first microporous membrane has thicknesses greater than 100 microns and the second microporous membrane has a thickness greater than 100 microns.

18. A layered polymeric microporous membrane prepared according to the method of claim 1.

19. A layered microporous membrane comprising:
a first microporous membrane,
a second microporous membrane bonded to the first microporous membrane at bond areas that cover less than 20 percent of the area of the layered microporous membrane.

20. The membrane of claim 19, wherein the bond areas cover less than 10 percent of the area of the layered microporous membrane.

21. The membrane of claim 19, wherein the first microporous membrane has a first microporous membrane melting point, the second microporous membrane has a second microporous membrane melting point, and a difference between the first microporous membrane melting point and the second microporous membrane melting point is at least 20 degrees Celsius.

22. The membrane of claim 19 wherein at least one of the first microporous membrane and the second microporous membrane includes a polymer.

23. The membrane of claim 19, wherein one of the first and second microporous membranes comprises polyethylene and one of the first and second microporous membrane comprises polypropylene.

24. The membrane of claim 19, wherein the first microporous membrane is a sieving membrane having:
an initial bubble point of at least 150 pounds per square,
a porosity of less than 55 percent, and
a thickness of less than 20 microns.

25. The membrane of claim 19, wherein the second microporous membrane has a thickness in a range from 20 to 200 microns.

26. The membrane of claim 24, wherein the second microporous membrane is a non-sieving membrane having:
an initial bubble point of less than 150 pounds per square,
a porosity of greater that 40 percent, and
a thickness of greater than 50 microns.

27. The membrane of claim 19, comprising a third microporous membrane bonded to the first microporous membrane and bonded to the second microporous membrane at bond areas.

28. The membrane of claim 19, wherein the first microporous membrane has thicknesses in a range from 5 to 100 microns and the second microporous membrane has a thickness in a range from 5 to 100 microns.

29. The membrane of claim 19, wherein the first microporous membrane has thicknesses in a range from 5 to 100 microns and the second microporous membrane has a thickness greater than 100 microns.

30. The membrane of claim 19, wherein the first microporous membrane has thicknesses greater than 100 microns and the second microporous membrane has a thickness greater than 100 microns.

31. A filter cartridge comprising a membrane of claim 19, the filter cartridge comprising a filter housing comprising an inlet, an outlet, and the membrane supported within the housing between the inlet and the outlet such that liquid entering the inlet passes through the membrane before passing through the outlet.

32. A method of using the filter cartridge of claim 31, the method comprising causing fluid to flow into the inlet, through the membrane, and out the outlet, wherein the fluid is useful in a semiconductor manufacturing processes.
